(19) United States
(12) Patent Application Publication
(10) Pub. No.: US 2009/0174614 A1
(43) Pub. Date: Jul. 9, 2009

(54) ANTENNA WITH MULTIPLE CO-LOCATED ELEMENTS WITH LOW MUTUAL COUPLING FOR MULTI-CHANNEL WIRELESS COMMUNICATION

(75) Inventor: Daniel D. Stancil, Mars, PA (US)

Correspondence Address: K&L GATES LLP, 535 SMITHFIELD STREET, PITTSBURGH, PA, 15222, US

(73) Assignee: Carnegie Mellon University, Pittsburgh, PA (US)

(21) Appl. No.: 12/350,409

(22) Filed: Jan. 8, 2009

Related U.S. Application Data
(60) Provisional application No. 61/010,479, filed on Jan. 9, 2008.

(51) Int. Cl. H01Q 21/00; H01Q 1/24

(52) U.S. Cl. 343/702; 343/727

(57) ABSTRACT

An antenna that has a number of co-located elements, with no (or very small) coupling between the various elements. The antenna may comprise one or more electric dipole elements, such as an electric tripole, co-located with one or more magnetic dipole elements, such as a magnetic tripole. The antenna has the property that although all of the electric and magnetic dipole elements are co-located, there is substantially no coupling between the elements. Some of the antenna elements may operate as transmitters and the others may act as receivers. The antenna elements may be tuned to different frequencies. The antenna may comprise less than six antenna elements. Also disclosed are example devices and systems that may utilize the antenna structure, such as a handheld wireless communication device and an access point of a HVAC wireless communication system.

### PRIORITY CLAIM

The present application claims priority to U.S. provisional application Ser. No. 61/010,479, filed Jan. 9, 2008, which is incorporated herein by reference in its entirety.

### BACKGROUND

Personal electronic devices are increasingly employing multiple wireless technologies, many of which are expected to operate simultaneously. These wireless technologies may include, for example, mobile phone voice and data wireless technologies (such as GSM/GPRS), wireless local area network technologies (such as IEEE 802.11), and short-range radio technologies (such as Bluetooth). Even though the technologies may use different bands or channels, the close proximity of the various antennas makes adjacent channel interference a difficult problem, requiring expensive and sophisticated channel filters to mitigate the interference.

Presently, isolation between antenna elements is usually achieved by spatially separating the various antenna elements, shielding them, or placing one in the pattern null of another. Physical separation requires an increase in the size of the antenna, which is a drawback for small or handheld devices. Shielding antenna elements from one another results in significant changes in the radiation pattern of each element, usually limiting the coverage of each antenna element. Finally, placing antenna elements in the nulls of another also affects the size of the antenna and/or adds other complexities.

Traditionally, it had been understood that the polarization of an electromagnetic wave gives two degrees of freedom that can be used to increase the capacity or reliability of a wireless communication link. Recently, this problem has been reexamined with the conclusion that in a rich multipath environment operating at a single carrier frequency, up to six degrees of freedom are available via the polarization of an electromagnetic wave. See M. R. Andrews et al., “Tripling the capacity of wireless communications using electromagnetic polarization,” Nature, vol. 409, no. 6818, pp. 316-318, 2001; D. D. Stancil et al., “Doubling wireless channel capacity using co-polarised, co-located electric and magnetic dipoles,” Electronics Letts., vol. 38, pp. 746-747 (2002).

### SUMMARY

In one general aspect, the present invention is directed to an antenna that has a number of co-located elements, with no (or very small) coupling between the various elements. For example, the antenna may comprise one or more electric dipole elements co-located with one or more magnetic dipole elements, such that there is substantially no coupling between the electric dipole elements and the magnetic dipole elements. In one embodiment, the antenna may comprise an electric tripole co-located with a magnetic tripole. The electric tripole may comprise three mutually perpendicular, co-located electric dipole antenna elements, and the magnetic tripole may comprise three mutually perpendicular, co-located magnetic dipole antenna elements. This antenna has the property that although all of the electric and magnetic dipole elements are co-located, they do not couple to one another (or have a vanishingly low coupling due to slight offsets in the positioning). Some of the antenna elements may operate as transmitters and the others may act as receivers. Further, the antenna elements may be tuned to different frequencies. In other embodiments, the antenna may comprise less than six antenna elements.

Also disclosed are example devices and systems that may utilize the antenna structure, such as a handheld wireless communication device and an access point of a HVAC wireless communication system.

### FIGURES

Various embodiments of the present invention are described herein by way of example in conjunction with the following figures, wherein:

FIGS. 1 and 3 are diagrams of antennas according to various embodiments of the present invention;

FIG. 2 is a diagram showing the magnetic flux linkage between an electric dipole antenna and a magnetic dipole antenna;

FIG. 4 is a diagram of a handheld wireless communication device according to various embodiments of the present invention; and

FIG. 5 is a diagram of a HVAC wireless communication system according to various embodiments of the present invention.

### DESCRIPTION

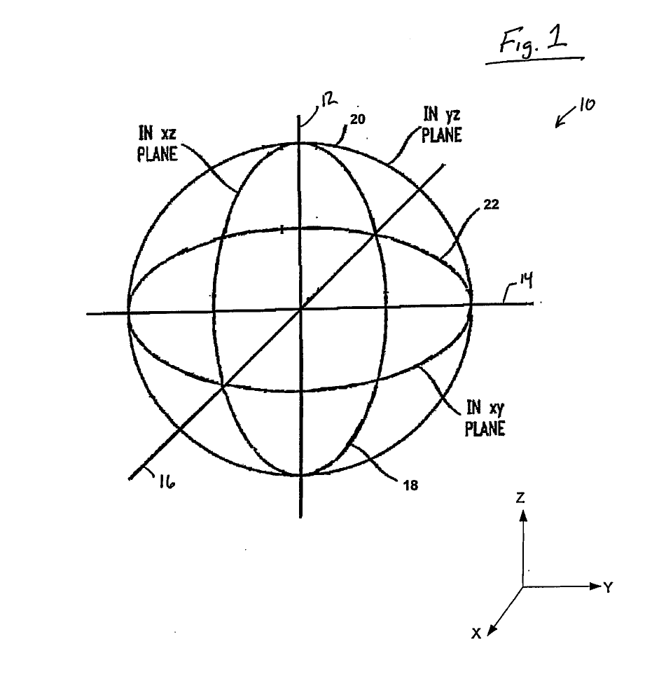

FIG. 1 provides an idealized three-dimensional view of an antenna 10 according to various embodiments of the present invention. As shown in FIG. 1, the antenna 10 may comprise an electric tripole that is co-located with a magnetic tripole. The electric tripole may comprise three mutually perpendicular, co-located electric dipole elements 12, 14, 16. The magnetic tripole may comprise three mutually perpendicular, co-located magnetic dipole elements 18, 20, 22. With respect to the 3-D Cartesian coordinate legend shown in FIG. 1, the electric dipole 12 may lie on the z-axis, the electric dipole 14 may lie on the y-axis, and the electric dipole 16 may lie on the x-axis, with each electric dipole 12-16 having its center intersecting at approximately the same point. The first magnetic dipole 18 may lie in the x-z plane, the second magnetic dipole 20 may lie in the y-z plane, and the third magnetic dipole 22 may lie in the x-y plane, with the center of each magnetic dipole 18-22 approximately at the same point at which the electric dipoles intersect. The antenna elements could be made of any material that is a suitable conductor of electricity.

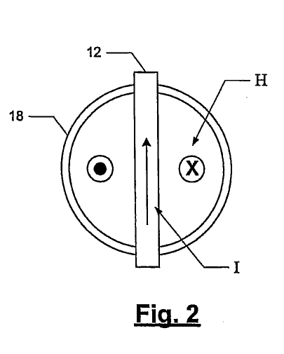

The antenna 10 of FIG. 1 has the property that although all of the electric and magnetic dipole elements 12-22 are co-located, they do not couple to one another (or have a vanishingly low coupling due to slight offsets in the positioning). The three electric dipoles 12-16 are mutually perpendicular; therefore, they do not couple to each other. Similarly, because the magnetic dipoles 18-22 are mutually perpendicular, they do not couple to one another. In addition, there is no (or very little) coupling between an electric dipole and a coplanar magnetic dipole (such as electric dipole 12 and magnetic dipole 18 in FIG. 1). This is because, if the electric dipole exactly bisects the magnetic dipole, there is theoretically no net flux linkage between current in the electric dipole and the magnetic dipole, as shown in FIG. 2. Thus, the dipole elements 12-22 have a vanishingly low or substantially no coupling therebetween in certain embodiments.

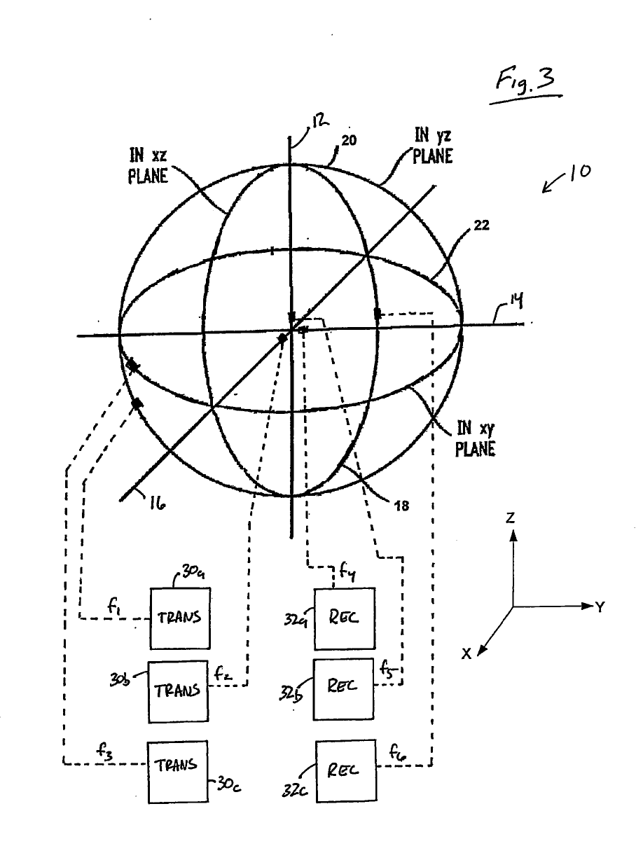

In various embodiments, some of the antenna elements 12-22 can be used to transmit electromagnetic signals and the others can be used to receive electromagnetic signals. In addition, the antenna elements 12-22 may be tuned to operate on different frequency channels or bands. FIG. 3 shows an embodiment where the electric dipole 16 and magnetic dipoles 20, 22 are connected to separate transmitters 30a-c, and electric dipoles 12, 14 and magnetic dipole 18 are connected to separate receivers 32a-c. Each of the transmitters 30a-c and receivers 32a-c may operate at different frequencies (denoted f₁ to f₆), for example. Of course, the example shown in FIG. 3 is but one example of the present invention and is not limiting. Different combinations of electric and magnetic dipoles could be used for transmitting and receiving. Nevertheless, due to the natural isolation between the antenna elements, adjacent channel interference between the various antenna elements is reduced.

The dimensions of the antenna elements 12-22 may be chosen based on the frequencies being used. For example, the electric dipoles 12-16 may have a length of about one-half wavelength. The circumferences of the magnetic dipoles 18-22 preferably are an appreciable fraction of the wavelength (such as around 100%). The magnetic dipoles 18-22 may assume any geometric shape that produces the radiation pattern of a magnetic dipole with uniform (or near uniform) current around the loop. For example, one or more of the magnetic dipoles 18-22 may be realized as a modified version of a Kandoian loop fed at four symmetric points around the circumference of the loop. More details regarding Kandoian loops may be found in A. G. Kandoian, “Three new antenna types and their applications,” Waves and Electrons, February 1946, pp. 70W-74W.

In other embodiment, less than six antenna elements could be used (with some still used for transmitting and some still used for receiving, and tuned to different frequencies). For example, in other embodiments, the following combinations may be realized:
one electric dipole co-located with one magnetic dipole;
one electric dipole co-located with two co-located, mutually perpendicular magnetic dipoles;
one electric dipole co-located with three co-located, mutually perpendicular magnetic dipoles;
two co-located, mutually perpendicular electric dipoles co-located with one magnetic dipole;
two co-located, mutually perpendicular electric dipoles co-located with two co-located, mutually perpendicular magnetic dipoles;
two co-located, mutually perpendicular electric dipoles co-located with three co-located, mutually perpendicular magnetic dipoles;
three co-located, mutually perpendicular electric dipole co-located with one magnetic dipole;
thee co-located, mutually perpendicular electric dipoles co-located with two co-located, mutually perpendicular magnetic dipoles; and
three co-located, mutually perpendicular electric dipoles co-located with three co-located, mutually perpendicular magnetic dipoles (shown in FIG. 1).
   An antenna with at least three elements may be realized, according to various embodiments, with planar multi-layer circuit board technology. For example, one dipole could be made on one layer (or layers), the second dipole could be fabricated on a second layer (or group of layers), and the third dipole could be fabricated on a third layer (or group of layers).

As shown in FIG. 3, the antenna elements may not be exactly co-located in order to facilitate electrical connections to all of the antenna elements. Preferably, the offsets, however, should be relatively small so that there is minimal coupling between the antenna elements. In addition, the magnetic dipoles preferably do not all have the same radius so that they do not intersect. Alternatively, their centers could be slightly offset to avoid intersection.

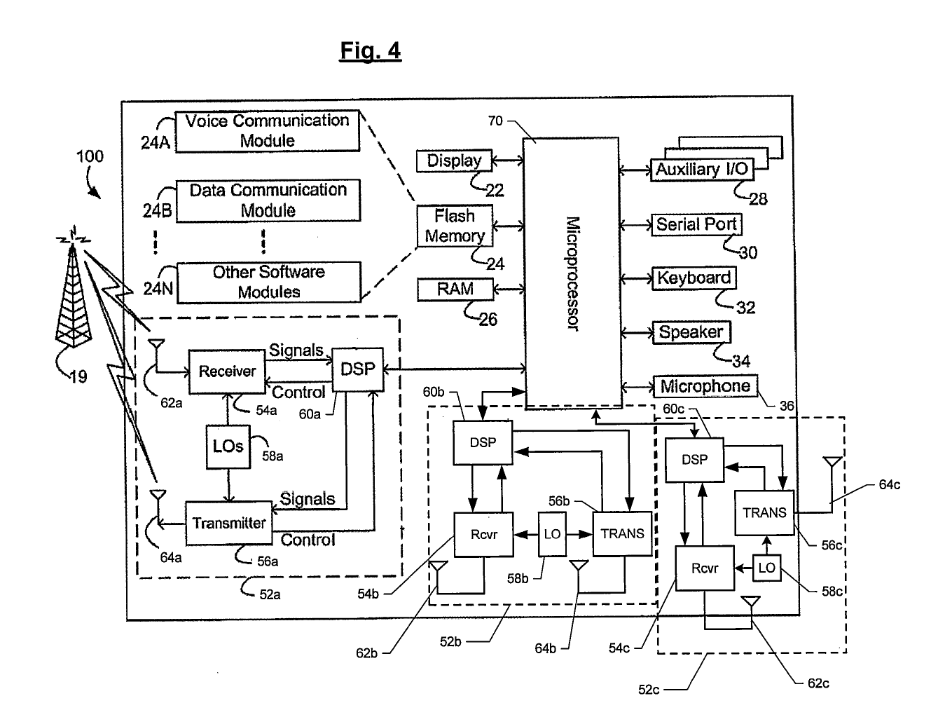

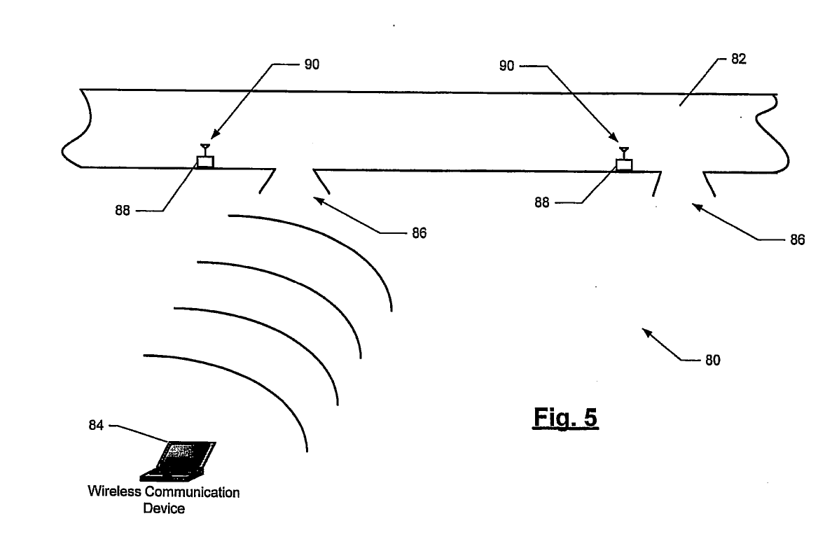

The antenna described above could be used in a variety of different applications. For example, the antenna could be used in a handheld wireless communication device. FIG. 4 is a simplified block diagram of a handheld wireless communication device 100 that may use the above-described antenna structure according to various embodiments. The illustrated device 50 includes three (3) transceivers 52a-c. Each transceiver 52a-c may comprise a receiver 54a-c, a transmitter 56a-c, one or more local oscillators (LOs) 58a-c, and a digital signal processor (DSP) 60a-c. If the receiver 54 and transmitter 56 of a transceiver 52 operate at the same frequency, one LO 58 may be used. If they operate at different frequencies, different LOs may be employed (e.g., one for the receiver and one for the transmitter). The DSPs may be used to send and receive signals to and from the transmitters 64a-c and the receivers 62a-c, and also to receive control information from the transmitters 64a-c and send control information to the receivers 62a-c. The transceivers 52a-c also may include two antennas each: one antenna 62a-c for the receiver and one antenna 64a-c for the transmitter.

The three transceivers 52a-c could be used for different types of two-way communications, and the six antennas 62a-c, 64a-c could be implemented using the above-described antenna structure with co-located electric and magnetic dipoles. That way, the six (6) antennas of the device 50 could consume a relatively small footprint of the device 50 while still realizing minimal coupling between the various antenna elements. In some embodiments, one or more of the transceivers 52a-c may use a single antenna that is used for both transmitting and receiving.

As one example, the first transceiver 52a may be used to communicate voice and data over a cellular network 19. The cellular network 19 may be, for example: a Global System for Mobile Communications/General Packet Radio Service (GSM/GPRS) network; a UMTS (Universal Mobile Telecommunications System) network; an Enhanced Data Rates for GSM Evolution (EDGE) network; a 3GSM network; or any other suitable wireless voice/data network. The second transceiver 52b may be used, for a wireless local area network (WLAN), such as a Wi-Fi network (e.g., IEEE 802.11 network) or a WiMAX network (IEEE 802.16). The third transceiver 52c could be used for another type of communication network, such as a Bluetooth network.

The DSPs 60a-c may communicate with a microprocessor 70, which may manage and control the overall operation of the device 50. As shown in FIG. 4, the device 50 may comprise a number of memory devices and a number of hardware components. The memory devices may comprise a RAM memory 26 and a flash memory 24. The hardware components may comprise a display 22, auxiliary input/output devices 28, a serial data port 30, a keyboard 32, a speaker 34, and a microphone 36. Within the flash memory 24, the device 50 may comprise a number of software modules that can be executed by the microprocessor 70. The modules may comprise a voice communication module 24A, a data communication module 24B, and other software modules 24N for carrying out other functions, such as modules for the WLAN and Bluetooth communications links, for example.

In another example, the above-described antenna could be used in the access points of a HVAC duct wireless communication system. HVAC duct wireless communication systems are generally known in the art. More information may be found in the following U.S. Patents, which are incorporated by reference: U.S. Pat. No. 6,781,477; U.S. Pat. No. 5,994,984; and U.S. Pat. No. 5,977,851. FIG. 4 is a simplified diagram of a HVAC duct wireless communication system 80 according to various embodiments of the present invention. The system 80 may comprise a HVAC duct 82, which acts as a waveguide for wireless communication signals propagating therein. A user at wireless communication device 84 may send and receive signals to and from the duct 82, which may be coupled into the duct 82 via vents (such as vent 86 shown in FIG. 4), louvers, and general points of leakage in the duct 82 (such as where pipes of the duct 82 are connected together to form a seam). The wireless communication device 84 may be any device that is capable of sending and receiving wireless communication signals, including GSM/GPRS, UMTS, EDGE, Wi-Fi, WiMAX, Bluetooth, etc. For example, the wireless communication device 84 may be, for example, a wireless-enabled computer (e.g., a desktop or laptop computer), a smartphone, a video game console, a peripheral device (e.g., a printer), etc. As shown in FIG. 4, the system 80 may comprise a number of wireless communication access points 88 in the duct 82, which may transmit and receive signals to and from the wireless communication device 84 and/or other access points 88.

In some installations, the HVAC system may employ a wireless network that utilizes a number of different channels. According to various embodiments, the access points 80 may comprise antennas 90 using the above-described structure, such as the antenna 10 shown in FIGS. 1 and 3, in which the antenna has a number of co-located electric and magnetic dipoles with reduced or substantially no coupling between the antenna elements. The various antenna elements of the antenna could be tuned to the respective frequency channels used by the system. Such an antenna may beneficial in a HVAC system that uses multiple channels to reduce the footprint size of the antenna.

The examples presented herein are intended to illustrate potential and specific implementations of the embodiments. It can be appreciated that the examples are intended primarily for purposes of illustration for those skilled in the art. No particular aspect of the examples is/are intended to limit the scope of the described embodiments. In addition, it is to be understood that the figures and descriptions of the embodiments have been simplified to illustrate elements that are relevant for a clear understanding of the embodiments, while eliminating, for purposes of clarity, other elements. Because the omitted elements are well known in the art and because they do not facilitate a better understanding of the embodiments, a discussion of such elements is not provided herein. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. An antenna comprising:
at least one electric dipole element; and
at least one magnetic dipole element, wherein the at least one magnetic dipole element is co-located with the at least one electric dipole element such that there is substantially zero coupling between the at least one electric dipole element and the at least one magnetic dipole element.

2. The antenna of claim 1, wherein the at least one electric dipole element comprises two or more co-located, mutually perpendicular electric dipole elements, wherein the at least one magnetic dipole element is co-located with the two or electric dipole elements such that there is substantially zero coupling between the two or more electric dipole elements and the at least one magnetic dipole element.

3. The antenna of claim 2, wherein the two or more co-located, mutually perpendicular electric dipole elements comprise three co-located, mutually perpendicular electric dipole elements.

4. The antenna of claim 3, wherein the at least one magnetic dipole element comprises two or more co-located, mutually perpendicular magnetic dipole elements, wherein the two or magnetic dipole elements are co-located with the electric dipole elements such that there is substantially zero coupling between the two or more magnetic dipole elements and the electric dipole elements.

5. The antenna of claim 4, wherein the two or more co-located, mutually perpendicular magnetic dipole elements comprise three co-located, mutually perpendicular magnetic dipole elements.

6. The antenna of claim 2, wherein the at least one magnetic dipole element comprises two or more co-located, mutually perpendicular magnetic dipole elements, wherein the two or magnetic dipole elements are co-located with the electric dipole elements such that there is substantially zero coupling between the two or more magnetic dipole elements and the electric dipole elements.

7. The antenna of claim 6, wherein the two or more co-located, mutually perpendicular magnetic dipole elements comprise three co-located, mutually perpendicular magnetic dipole elements.

8. The antenna of claim 1, wherein the at least one magnetic dipole element comprises two or more co-located, mutually perpendicular magnetic dipole elements, wherein the at least one electric dipole element is co-located with the two or magnetic dipole elements such that there is substantially zero coupling between the two or more magnetic dipole elements and the at least one electric dipole element.

9. The antenna of claim 8, wherein the two or more co-located, mutually perpendicular magnetic dipole elements comprise three co-located, mutually perpendicular magnetic dipole elements.

10. The antenna of claim 8, wherein each of the magnetic dipole elements comprises a Kandoian loop.

11. The antenna of claim 1, wherein the at least one electric dipole and the at least one magnetic dipole are tuned to different frequencies.

12. A wireless communication device comprising:
two or more transceivers;
an antenna connected to the two ore more transceivers, wherein the antenna comprises:
at least one electric dipole element; and
at least one magnetic dipole element, wherein the at least one magnetic dipole element is co-located with the at least one electric dipole element such that there is substantially zero coupling between the at least one electric dipole element and the at least one magnetic dipole element.

13. The wireless communication device of claim 12, wherein the at least one electric dipole element comprises two or more co-located, mutually perpendicular electric dipole elements, wherein the at least one magnetic dipole element is co-located with the two or electric dipole elements such that there is substantially zero coupling between the two or more electric dipole elements and the at least one magnetic dipole element.

14. The wireless communication device of claim 13, wherein the two or more co-located, mutually perpendicular electric dipole elements comprise three co-located, mutually perpendicular electric dipole elements.

15. The wireless communication device of claim 14, wherein the at least one magnetic dipole element comprises two or more co-located, mutually perpendicular magnetic dipole elements, wherein the two or magnetic dipole elements are co-located with the electric dipole elements such that there is substantially zero coupling between the two or more magnetic dipole elements and the electric dipole elements.

16. The wireless communication device of claim 15, wherein the two or more co-located, mutually perpendicular magnetic dipole elements comprise three co-located, mutually perpendicular magnetic dipole elements.

17. The wireless communication device of claim 13, wherein the at least one magnetic dipole element comprises two or more co-located, mutually perpendicular magnetic dipole elements, wherein the two or magnetic dipole elements are co-located with the electric dipole elements such that there is substantially zero coupling between the two or more magnetic dipole elements and the electric dipole elements.

18. The wireless communication device of claim 17, wherein the two or more co-located, mutually perpendicular magnetic dipole elements comprise three co-located, mutually perpendicular magnetic dipole elements.

19. The wireless communication device of claim 12, wherein the at least one magnetic dipole element comprises two or more co-located, mutually perpendicular magnetic dipole elements, wherein the at least one electric dipole element is co-located with the two or magnetic dipole elements such that there is substantially zero coupling between the two or more magnetic dipole elements and the at least one electric dipole element.

20. The wireless communication device of claim 19, wherein the two or more co-located, mutually perpendicular magnetic dipole elements comprise three co-located, mutually perpendicular magnetic dipole elements.

21. The wireless communication device of claim 12, wherein the at least one electric dipole and the at least one magnetic dipole are tuned to different frequencies.

22. A communication system comprising:
a HVAC duct;
a wireless communication access point positioned in the HVAC duct, wherein the access point comprises an antenna, wherein the antenna comprises:
at least one electric dipole element; and
at least one magnetic dipole element, wherein the at least one magnetic dipole element is co-located with the at least one electric dipole element such that there is substantially zero coupling between the at least one electric dipole element and the at least one magnetic dipole element.

23. The communication system of claim 22, wherein the at least one electric dipole element comprises two or more co-located, mutually perpendicular electric dipole elements, wherein the at least one magnetic dipole element is co-located with the two or electric dipole elements such that there is substantially zero coupling between the two or more electric dipole elements and the at least one magnetic dipole element.

24. The communication system of claim 23, wherein the two or more co-located, mutually perpendicular electric dipole elements comprise three co-located, mutually perpendicular electric dipole elements.

25. The communication system of claim 24, wherein the at least one magnetic dipole element comprises two or more co-located, mutually perpendicular magnetic dipole elements, wherein the two or magnetic dipole elements are co-located with the electric dipole elements such that there is substantially zero coupling between the two or more magnetic dipole elements and the electric dipole elements.

26. The communication system of claim 25, wherein the two or more co-located, mutually perpendicular magnetic dipole elements comprise three co-located, mutually perpendicular magnetic dipole elements.

27. The communication system of claim 23, wherein the at least one magnetic dipole element comprises two or more co-located, mutually perpendicular magnetic dipole elements, wherein the two or magnetic dipole elements are co-located with the electric dipole elements such that there is substantially zero coupling between the two or more magnetic dipole elements and the electric dipole elements.

28. The communication system of claim 27, wherein the two or more co-located, mutually perpendicular magnetic dipole elements comprise three co-located, mutually perpendicular magnetic dipole elements.

29. The communication system of claim 22, wherein the at least one magnetic dipole element comprises two or more co-located, mutually perpendicular magnetic dipole elements, wherein the at least one electric dipole element is co-located with the two or magnetic dipole elements such that there is substantially zero coupling between the two or more magnetic dipole elements and the at least one electric dipole element.

30. The communication system of claim 29, wherein the two or more co-located, mutually perpendicular magnetic dipole elements comprise three co-located, mutually perpendicular magnetic dipole elements.

31. The communication system of claim 22, wherein the at least one electric dipole and the at least one magnetic dipole are tuned to different frequencies
